(19) United States
(12) Patent Application Publication
(10) Pub. No.: US 2026/0236419 A1
(43) Pub. Date: Aug. 13, 2026

(54) LEARNING DEVICE, INFERENCE DEVICE, AND SEMICONDUCTOR DEVICE

(71) Applicant: Mitsubishi Electric Corporation, Chiyoda-ku, Tokyo (JP)

(72) Inventors: Naoki TSUCHIYA, Chiyoda-ku, Tokyo (JP); Atsuhiro MORI, Chiyoda-ku, Tokyo (JP); Kyohei SUWABE, Chiyoda-ku, Tokyo (JP)

(73) Assignee: Mitsubishi Electric Corporation, Chiyoda-ku, Tokyo (JP)

(21) Appl. No.: 19/154,038

(22) PCT Filed: Mar. 7, 2023
(86) PCT No.: PCT/JP2023/008575

§ 371 Date: Aug. 6, 2025

(51) Int. Cl. G06F 13/362; G06F 13/16

(52) U.S. Cl. CPC G06F 13/362; G06F 13/1605; G06F 2213/0064

(57) ABSTRACT

A learning device includes: a data acquisition unit to obtain training data including a transfer request from a bus master, and a bus occupancy time to receipt, by the bus master, of a transfer response from a bus slave to the transfer request from the bus master; and a model generation unit to generate, using the training data, a learned model for inferring a bus occupancy time from a transfer request from a bus master.

### TECHNICAL FIELD

The present disclosure relates to a learning device, an inference device, and a semiconductor device.

### BACKGROUND ART

A device that arbitrates transfer requests from multiple bus masters is known.

For example, PTL 1 discloses a device in which, an interconnect, upon receiving transfer requests from multiple bus masters, outputs to a memory controller a transfer request issued by a master having the highest priority, according to priorities that are set to the respective bus masters. As the interconnect obtains a response to the transfer request output to the memory controller, the interconnect selects and outputs the transfer request from a bus master having the next highest priority to the memory controller.

### CITATION LIST

### Patent Literature

PTL 1: Japanese Patent Laying-Open No. 2019-220060

### SUMMARY OF INVENTION

### Technical Problem

The conventional bus control device as disclosed in PTL 1 is unable to grant a bus access priority on a transfer request basis.

Therefore, an object of the present disclosure is to provide a learning device, an inference device, and a semiconductor device, which grant a bus access priority on a transfer request basis.

### Solution to Problem

A learning device according to the present disclosure includes: a data acquisition unit to obtain training data including: a transfer request from a bus master; and a bus occupancy time to receipt, by the bus master, of a transfer response from a bus slave in response to the transfer request from the bus master; and a model generation unit to generate a learned model for inferring the bus occupancy time from the transfer request from the bus master, using the training data.

An inference device according to the present disclosure includes: a data acquisition unit to obtain a transfer request from a bus master; and an inference unit to output a bus occupancy time from the transfer request from the bus master obtained by the data acquisition unit, using a learned model for inferring a bus occupancy time.

A semiconductor device according to the present disclosure includes: a plurality of bus masters; plurality of bus slaves; a bus, interconnecting the plurality of bus masters and the plurality of bus slaves, for address transfers and data transfers between the plurality of bus masters and the plurality of bus slaves; and a bus control device to control the address transfers and the data transfers via the bus.

The bus control device includes: a memory device storing past transfer requests output from plurality of bus masters, priorities set to the transfer requests, and bus occupancy times by the data transfers based on the transfer requests; and a learning device, including: a data acquisition unit which obtains, as training data, an attribute of a transfer request whose bus occupancy time is shorter than a first occupancy time among the past transfer requests and a priority of the transfer request from the memory device; and a model generation unit which generates, using the training data, a learned model for estimating, from the attribute of the transfer request, a priority allowing the bus occupancy time to be shorter than the first occupancy time.

The learning device according to the present disclosure includes: a data acquisition unit to obtain training data including conflicting transfer requests from a plurality of bus masters and a transfer request to be granted a bus access right among the conflicting transfer requests from the plurality of bus masters; and a model generation unit to generate, using the training data, a learned model for determining, from conflicting transfer requests from a plurality of bus masters, the transfer request to be granted the bus access right among the conflicting transfer requests from the plurality of bus masters.

An inference device according to the present disclosure includes: a data acquisition unit to obtain conflicting transfer requests from a plurality of bus masters; and an inference unit to determine a transfer request to be granted a bus access right among the conflicting transfer requests from the plurality of bus masters, from the conflicting transfer requests from the plurality of bus masters obtained by the data acquisition unit, using a learned model for determining from conflicting transfer requests from a plurality of bus masters a transfer request to be granted a bus access right among the conflicting transfer requests from the plurality of bus masters.

### Advantageous Effects of Invention

According to the present disclosure, the bus access priority can be granted on a transfer request basis.

### BRIEF DESCRIPTION OF DRAWINGS

FIG. 1 is a diagram depicting a configuration of a semiconductor device according to Embodiment 1.

FIG. 2 is a diagram depicting a configuration of a bus control device 10.

FIG. 3 is a block diagram of a learning device 13.

FIG. 4 is a flowchart for a learning process by the learning device 13 according to Embodiment 1.

FIG. 5 is a block diagram of an inference device 14.

FIG. 6 is a flowchart for an inference process by the inference device 14 according to Embodiment 1.

FIG. 7 is a flowchart for a learning process by a learning device 13 according to Embodiment 2.

FIG. 8 is a diagram for illustrating an example of transitions of a state and an action during learning.

FIG. 9 is a flowchart for an inference process by an inference device 14 according to Embodiment 2.

FIG. 10 is a diagram showing a configuration of a bus control device 10 whose functions are implemented using software.

### DESCRIPTION OF EMBODIMENTS

Hereinafter, embodiments according to the present disclosure will be described, with reference to the accompanying drawings.

### Embodiment 1

### <Description of Semiconductor Device>

FIG. 1 is a diagram depicting a configuration of a semiconductor device according to Embodiment 1.

The semiconductor device includes multiple bus masters M1 to MN, multiple bus slaves S1 to SN, a bus control device 10, and a bus 100. In the following description, bus masters M1 to MN may be collectively referred to as a bus master M, and bus slaves S1 to SN may be collectively referred to as a bus slave S.

Bus masters M1 to MN output transfer requests.

Bus slaves S1 to SN respond to the transfer requests. In response to the transfer request from a bus master Mj, a bus slave Si transmits data to bus master Mj through bus 100.

Bus control device 10 controls address transfers and data transfers.

An address and data are transferred to bus 100. Bus masters M1 to MN and bus slaves S1 to SN are interconnected by bus 100.

Bus control device 10 determines the priority of a transfer request. Bus control device 10 determines a processing order of transfer requests, based on priorities granted to the transfer requests.

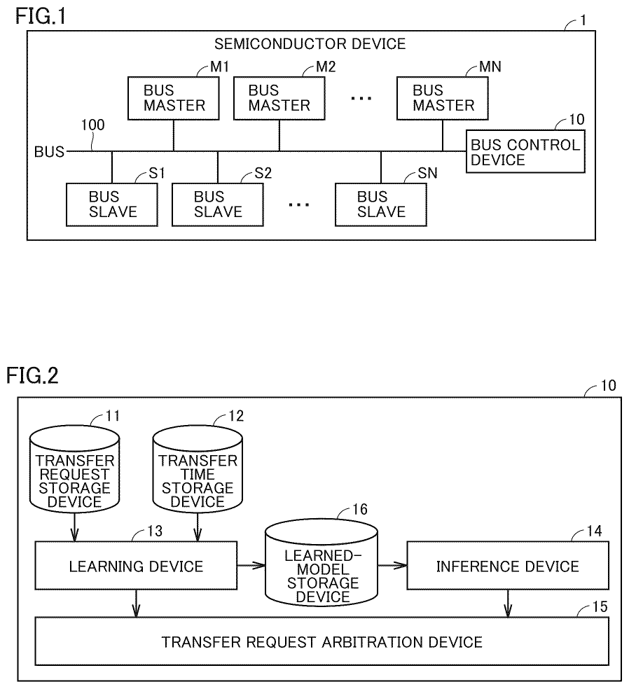

FIG. 2 is a diagram depicting a configuration of bus control device 10.

Bus control device 10 includes a transfer request storage device 11, a transfer time storage device 12, a learning device 13, an inference device 14, a transfer request arbitration device 15, and a learned-model storage device 16.

Transfer request storage device 11 stores past transfer requests from bus master M.

Transfer time storage device 12 stores bus occupancy times, which are response times by bus slave S to the past transfer requests. The bus occupancy time may be a time taken for a bus slave to transfer data to a bus slave through the bus, in response to a transfer request.

Learning device 13 obtains information from transfer request storage device 11 and transfer time storage device 12 to perform a learning process to generate a learned model. The learned model is stored into learned-model storage device 16.

Using the learned model stored in learned-model storage device 16, inference device 14 performs an inference process, on a transfer request, for estimating a priority allowing a bus occupancy time to be shorter than a first occupancy time.

Transfer request arbitration device 15 rearranges the processing order of the transfer requests output from bus masters M.

### <Learning Phase>

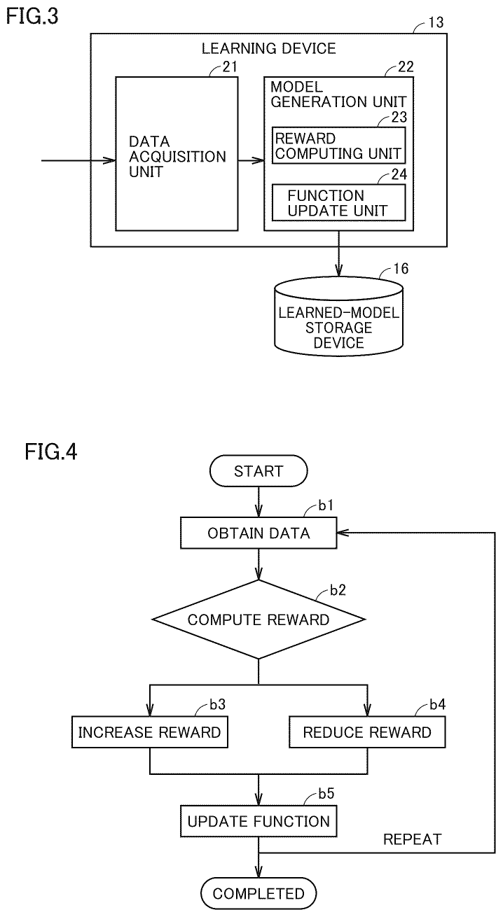

FIG. 3 is a block diagram of learning device 13. Learning device 13 includes a data acquisition unit 21 and a model generation unit 22.

Data acquisition unit 21 obtains data regarding the past transfer requests from transfer request storage device 11 and transfer time storage device 12, as training data.

Model generation unit 22 classifies the training data by attribute of the past transfer requests. Based on the training data including a burst size, a burst length, and a one-shot size, which are included in the attributes of the transfer request, the address information of bus slave S, and priorities based on a result of the arbitration by transfer request arbitration device 15, model generation unit 22 learns: an attribute that has a priority allowing the bus occupancy time to be shorter than the first occupancy time; and an attribute that has a priority allowing the bus occupancy time to be longer than a second occupancy time. In other words, model generation unit 22 generates a learned model that infers a priority, allowing reduction of the bus occupancy time, from the data regarding the past transfer requests in transfer request storage device 11 and transfer time storage device 12. The burst size represents the size of unit data (e.g., 32 bytes) at a burst transmission, and the burst length represents the number of unit data items at the burst transmission. The one-shot size represents the size of data (e.g., 32 bytes) at a typical transmission.

The learning algorithm used by model generation unit 22 can be a well-known algorithm such as supervised learning, unsupervised learning, reinforcement learning, etc. By way of example, a description is given where reinforcement learning is applied to the learning algorithm. In the reinforcement learning, an agent (an actor) within certain environment observes the current state (a parameter of the environment) to determine an action to be taken. The action by the agent dynamically changes the environment, and a reward is granted to the agent in response to the change in environment. The agent repeats this to learn an action policy allowing a largest reward to be granted to the agent through the series of actions. Q-learning and TD-learning are known as representative approaches of the reinforcement learning. For example, in the case of Q-learning, a general update equation for an action value function Q (s, a) is expressed as Equation (1).

$$Q ( {s}_{t} , {a}_{t} ) ← Q ( {s}_{t} , {a}_{t} ) + α ( {r}_{t + 1} + γ {max}_{a} Q ( {s}_{t + 1} , {a}_{t} ) - Q ( {s}_{t} , {a}_{t} ) ) \qquad ( 1 )$$

In Equation (1), “st” denotes the state of the environment at time “t”, and “at” denotes an action at time “t”. Action “at” changes the state to “st+1”. “rt+1” denotes a reward that is granted depending on that change in state, γ denotes a discount factor, and α denotes a learning coefficient. Note that γ is in a range of 0<γ≤1, and α is in a range of 0<α≤1. The bus occupancy time is action “at”, the transfer request is state “st”, and the best action “at” in state “st” at time “t” is learned.

If action value function Q of an action “a” having a highest Q value at time “t+1” is greater than action value function Q of action “a” performed at time “t”, the update equation, expressed as Equation (1), increases action value function Q. Otherwise, the update equation reduces action value function Q. Stated differently, the update equation updates action value function Q (s, a) so that the action value function Q of action “a” at time “t” is close to the best action value at time “t+1”. The best action value in the certain environment thereby propagates sequentially to action values in the previous environment.

As noted above, if the learned model is generated by the reinforcement learning, model generation unit 22 includes a reward computing unit 23 and a function update unit 24.

Reward computing unit 23 computes the reward, based on the data regarding the past transfer requests obtained from transfer request storage device 11 and transfer time storage device 12. Reward computing unit 23 computes a reward r based on transfer requests categorized by attribute. For example, if the attribute has a priority allowing the bus occupancy time to be shorter than the first occupancy time, reward computing unit 23 increases reward r (e.g., gives a reward of “1”). If the attribute has a priority allowing the bus occupancy time to be longer than the second occupancy time, on the other hand, reward computing unit 23 reduces reward r (e.g., gives a reward of “−1”).

Function update unit 24 updates a function for determining the priority allowing the bus occupancy time to be shorter than the first occupancy time, according to the reward computed by reward computing unit 23, and outputs the function to learned-model storage device 16. For example, in the case of Q-learning, action value function Q (st, at), expressed as Equation (1), is used as a function for calculating the priority allowing the bus occupancy time to be shorter than the first occupancy time.

The learning as the above is repeatedly performed. Learned-model storage device 16 stores action value function Q (st, at) updated by function update unit 24, that is, a learned model.

Next, referring to FIG. 4, the learning process by learning device 13 is described. FIG. 4 is a flowchart for the learning process by learning device 13 according to Embodiment 1.

In step b1, data acquisition unit 21 obtains the data regarding the past transfer requests from transfer request storage device 11 and transfer time storage device 12, as training data.

In step b2, model generation unit 22 classifies the training data by attribute of the past transfer requests. Model generation unit 22 computes a reward, based on a response time by bus slave S. Specifically, reward computing unit 23 classifies the training data by attribute of the transfer requests, obtains response times by bus slaves S for the categorized attributes, and determines whether to increase or reduce the reward based on a predetermined bus occupancy time.

If determined to increase the reward, reward computing unit 23, in step b3, increases the reward. If determined to reduce the reward, in contrast, reward computing unit 23, in step b4, reduces the reward.

In step b5, based on the reward computed by reward computing unit 23, function update unit 24 updates action value function Q (st, at), expressed as Equation (1), stored in learned-model storage device 16.

Learning device 13 repeatedly performs these steps b1 to b5. The generated action value function Q (st, at) is stored into learned-model storage device 16, as a learned model.

While learning device 13 according to the present embodiment stores the learned model into learned-model storage device 16 provided external to learning device 13, learned-model storage device 16 may be included inside learning device 13.

### <Exploit Phase>

FIG. 5 is a block diagram of inference device 14. Inference device 14 includes a data acquisition unit 31 and an inference unit 32.

Data acquisition unit 31 obtains a transfer request from bus master M.

Inference unit 32 uses the learned model to infer a priority allowing the bus occupancy time to be shorter than the first occupancy time. In other words, as the transfer request obtained by data acquisition unit 31 is input to the learned model, the learned model infers the priority that allows the bus occupancy time, in a predetermined period of time, suited for the transfer request from bus master M to be shorter than the first occupancy time.

Note that while the learned model learned on model generation unit 22 of bus control device 10 is used to output the priority allowing the bus occupancy time by transfer request arbitration device 15 to be shorter than the first occupancy time in the present embodiment, a learned model may be obtained from other bus control device 10 and the priority allowing the bus occupancy time by transfer request arbitration device 15 to be shorter than the first occupancy time may be output based on this learned model.

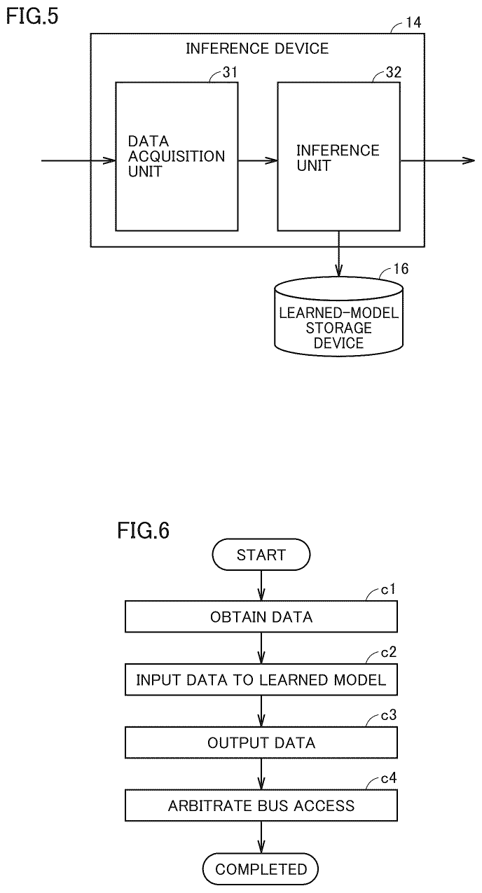

Next, referring to FIG. 6, a process is described for obtaining, using the learned model, the priority allowing the bus occupancy time by transfer request arbitration device 15 to be shorter than the first occupancy time. FIG. 6 is a flowchart for the inference process by inference device 14 according to Embodiment 1.

In step c1, data acquisition unit 31 obtains a transfer request from bus master M.

In step c2, inference unit 32 inputs the transfer request obtained in step c1 to the learned model stored in learned-model storage device 16, and obtains a priority allowing the bus occupancy time to be shorter than the first occupancy time.

In step c3, inference unit 32 outputs to transfer request arbitration device 15 the priority allowing the bus occupancy time to be shorter than the first occupancy time.

In step c4, using the priority allowing the bus occupancy time to be shorter than the first occupancy time, transfer request arbitration device 15 arbitrates the bus access. This can grant the priority on a transfer request basis, improving the transmission efficiency.

Note that while the reinforcement learning is applied to the learning algorithm for use by inference unit 32 in the present embodiment, the present disclosure is not limited thereto. Besides the reinforcement learning, for example, supervised learning, unsupervised learning, or semi-supervised learning is applicable to the learning algorithm.

Deep learning, which learns extraction of a feature itself, can also be used as the learning algorithm for use in model generation unit 22, and machine learning may be performed according to other well-known method, for example, a neural network, genetic programming, functional and logic programming, a support vector machine, etc.

Note that the learning device 13 and inference device 14 may be, for example, devices separate from bus control device 10, and are connected to bus control device 10 via a network. Moreover, learning device 13 and inference device 14 may be built in bus control device 10. Furthermore, learning device 13 and inference device 14 may reside on a cloud server.

Moreover, model generation unit 22 may use the training data, obtained from multiple bus control devices 10, to learn the response time information of bus slaves S. Note that the model generation unit 22 may obtain the training data from multiple bus control devices 10 that are used in the same area, or may use the training data collected from multiple bus control devices 10 operating independent of each other in different areas, to learn the response time information of bus slaves S. Moreover, bus control device 10 for collecting the training data can be added to or removed from a target on the way. Furthermore, learning device 13 having learned the response time information of bus slaves S for a certain bus control device 10 may be applied to a different bus control device 10, and re-learn and update the response time information of bus slaves S for the different bus control device 10.

### Variation 1 of Embodiment 1

In the above embodiment, learning device 13 uses the reinforcement learning to generate the learned model. However, learning device 13 may use supervised learning to generate the learned model.

Transfer request storage device 11 and transfer time storage device 12 store the past transfer requests output from bus masters M, priorities set to the transfer requests, and bus occupancy times by data transfers based on the transfer requests.

As training data, data acquisition unit 21 included in learning device 13 obtains the attribute (input data) of a transfer request allowing the bus occupancy time to be shorter than the first occupancy time, among the past transfer requests, and the priority (the training data) set to the transfer request.

Using the training data, model generation unit 22 included in learning device 13 generates a learned model which estimates, by supervised learning, the priority allowing the bus occupancy time to be shorter than the first occupancy time from the attributes of transfer requests. The learned model is stored into learned-model storage device 16.

Data acquisition unit 31 included in inference device 14 obtains the attributes of the transfer requests from bus masters M.

Using the learned model that estimates, from the attributes of the transfer requests, the priority allowing the bus occupancy time to be shorter than the first occupancy time, inference unit 32 included in inference device 14 estimates the priority allowing the bus occupancy time to be shorter than the first occupancy time, from the attributes of the transfer requests obtained by data acquisition unit 31.

According to the priority inferred by inference unit 32, transfer request arbitration device 15 rearranges the processing order of the transfer requests output from bus masters M.

### Variation 2 of Embodiment 1

Learned-model storage device 16 stores learned models for three access request patterns.

Learning device 13 creates a learned model 1, using, as training data, a pattern in which the percentage of transfer requests allowing the bus occupancy time to be shorter than the first occupancy time is greater than or equal to a first threshold (e.g., 80%). Learning device 13 creates a learned model 2, using, as training data, a pattern in which the percentage of transfer requests allowing the bus occupancy time to be longer than the second occupancy time is greater than or equal to the first threshold (e.g., 80%). Learning device 13 creates a learned model 3, using, as training data, a pattern in which the percentage of transactions allowing the bus occupancy time to be shorter than the first occupancy time is 50% and the percentage of transactions allowing the bus occupancy time to be longer than the second occupancy time is 50%.

Inference device 14 holds a predetermined number of transfer requests, and selects any one of learned models 1, 2, and 3 by computing the percentage of transfer requests allowing the bus occupancy time to be shorter than the first occupancy time and the percentage of transfer requests allowing the bus occupancy time to be longer than the second occupancy time. Using the selected learned model, inference device 14 implements the inference. Transfer request arbitration device 15 arbitrates the transfer requests, based on a result of the inference.

For example, while performing the inference using the learned model 1, if the pattern of a result of the arbitration by transfer request arbitration device 15 matches the learned model 2, inference device 14 switches the learned model being in use to learned model 2 and performs the inference, and transfer request arbitration device 15 arbitrates the transfer requests, based on a result of the inference.

### Variation 3 of Embodiment 1

The semiconductor device includes multiple bus masters, multiple bus slaves, a bus interconnecting the bus masters and the bus slaves for address transfers and data transfers between the bus masters and the bus slaves, and a bus control device for controlling the address transfers and the data transfers via the bus. The bus control device includes: a transfer request storage device storing transfer request information output from the bus masters; a transfer time storage device storing response times by the bus slaves to transfer requests output from the bus masters; a learning unit that: obtains past information from the transfer request storage device and the transfer time storage device; classifies the past transfer requests by attribute; selects, from the information on response times by bus slaves belonging to that attribute, and truly learns an attribute having a priority allowing the bus occupancy time to be shorter than the first occupancy time; and classifies the past transfer requests by attribute; selects, from the information on response times by bus slaves belonging to that attribute, and falsely learns an attribute in which the bus occupancy time is longer than a predetermined time, thereby performing the learning process for estimating a priority allowing the bus occupancy time to be shorter than the first occupancy time; an inference unit that performs an inference process for estimating a priority allowing the bus occupancy time to be shorter than the first occupancy time, from the past information from the transfer request storage device and the transfer time storage device and the transfer request information output from the bus masters; and a transfer request arbitration device that rearranges the processing order of the transfer requests output from the bus masters, according to the priorities inferred by the inference unit.

The learning unit may include: a data acquisition unit that obtains the training data, including the priority to be granted to the transfer request arbitration device, response times by the bus slaves, the priority of the transfer request arbitration device obtained by accumulating access requests from the bus masters in a predetermined period of time, and response times by the bus slaves; and the model generation unit that uses the training data to generate the learned model for inferring the priority and response times by the bus slaves from the access requests from the bus masters accumulated in a predetermined period of time in the semiconductor device.

The learning unit may increase the reward in the learning, depending on a degree of shortening of the average bus occupancy time, a degree of reduction of the bus slave transfer request acceptance time, or a degree of reduction of the bus master transfer request acceptance time, as a reference for increasing the reward during the learning.

The bus master transfer request acceptance time is a period from a time a bus master transmits a transfer request to a time the bus master receives the bus access right. The bus slave transfer request acceptance time is a period from a time the bus master transmits a transfer request to a time the bus master is granted the bus access right and transmits the transfer request to a bus slave and the bus slave receives the transfer request.

The learning unit may reduce the reward, depending on a degree of extension of the average bus occupancy time, or a degree of increase of the bus slave transfer request acceptance time, or a degree of increase of the bus master transfer request acceptance time, as a reward reduction criterion during the learning.

The inference unit may include: the data acquisition unit which obtains an access request from a bus master in a predetermined period of time; and an inference unit which outputs, using the learned model for inferring a priority of a semiconductor device and a response time by a bus slave from an access request from a bus master in a predetermined period of time, a priority and a response time by the bus slave from the access request from the bus master in the predetermined period of time obtained by the data acquisition unit.

In order to enable selection of a learned model for use to a pattern of the access request to arbitrate the access requests, the inference device may include a learned model storage unit holding multiple learned models.

### Embodiment 2

### <Learning Phase>

A transfer request arbitration device 15 obtains transfer requests from bus masters M. If the transfer requests from multiple bus masters M conflict, transfer request arbitration device 15 outputs the conflicting transfer requests to a learning device 13.

A data acquisition unit 21 obtains training data, including the conflicting transfer requests from multiple bus masters M, and a transfer request to be granted the bus access right among the conflicting transfer requests from bus masters M. The transfer request includes the address of a bus master M, the address of a bus slave S, the size of data to be transferred, and a time the transfer request is received. Using the training data, a model generation unit 22 generates, from the conflicting transfer requests from bus masters M (the state), a learned model that determines (the action) a transfer request to be granted the bus access right among the conflicting transfer requests from bus masters M.

Transfer request arbitration device 15 grants a bus access right to a transfer request to be granted the bus access right among the transfer requests.

The learning algorithm used by model generation unit 22 can be a well-known algorithm such as supervised learning, unsupervised learning, reinforcement learning, etc. By way of example, a description is given where reinforcement learning is applied to the learning algorithm. In the reinforcement learning, an agent (an actor) within certain environment observes the current state (a parameter of the environment) to determine an action to be taken. The action by the agent dynamically changes the environment, and a reward is granted to the agent in response to the change in environment. The agent repeats this to learn an action policy allowing a largest reward to be granted to the agent through the series of actions. Q-learning and TD-learning are known as representative approaches of the reinforcement learning. For example, in the case of Q-learning, a general update equation for an action value function Q (s, a) is expressed as Equation (1).

In Equation (1), “st” denotes the state of the environment at time “t”, and “at” denotes an action at time “t”. Action “at” changes the state to “st+1”. “rt+1” denotes a reward that is granted depending on that change in state, γ denotes a discount factor, and a denotes a learning coefficient. Note that γ is in a range of 0<γ≤1, and a is in a range of 0<α≤1. Transfer requests being conflicting is a state “s”, determining a transfer request to which the bus access right is granted among the conflicting transfer requests is action “at”, and the best action “at” in state “st” at time “t” is learned.

If action value function Q of an action highest at time “t+1” is greater than action value function Q of action “a” performed at time “t”, the update equation, expressed as Equation (1), increases action value function Q. Otherwise, the update equation reduces action value function Q. Stated differently, the update equation updates action value function Q (s, a) so that the action value function Q of action “a” at time “t” is close to the best action value at time “t+1”. The best action value in the certain environment thereby propagates sequentially to action values in the previous environment.

A reward computing unit 23 calculates, as a transaction time of a transfer request, a difference between a time the reward computing unit 23 receives the transfer request to which the reward computing unit 23 has granted the bus access right and a time the data transmission based on the transfer request ended. Reward computing unit 23 calculates an average time of transactions, based on one or more transaction times in the past and the calculated transaction time. If the average transaction time decreases, reward computing unit 23 increases reward r (e.g., gives a reward of “1”). If the average transaction time increases, reward computing unit 23 reduces reward r (e.g., gives a reward of “−1”).

A function update unit 24 updates a function for determining a transfer request to be granted the bus access right among the conflicting transfer requests, according to the computed reward, and outputs the function to a learned-model storage device 16. For example, in the case of Q-learning, function update unit 24 uses action value function Q (st, at), expressed as Equation (1), as the function for determining a transfer request to be granted the bus access right among conflicting transfer requests.

The learning as the above is repeatedly performed. Learned-model storage device 16 stores action value function Q (st, at) updated by function update unit 24, that is, a learned model.

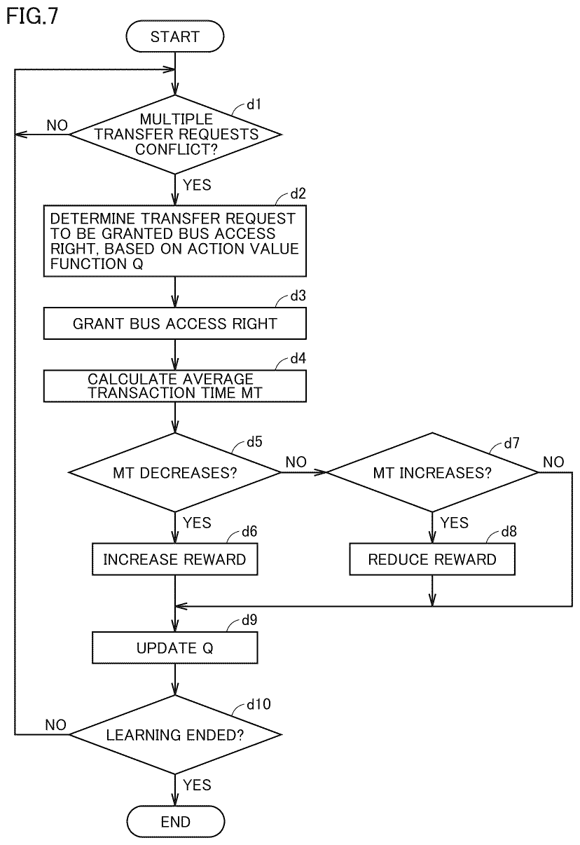

Next, referring to FIG. 7, a learning process by learning device 13 is described. FIG. 7 is a flowchart for the learning process by learning device 13 according to Embodiment 2.

In step d1, transfer request arbitration device 15, if transfer requests from multiple bus masters M conflict, moves the process to step d2.

In step d2, transfer request arbitration device 15 outputs attributes of the conflicting transfer requests to learning device 13. Data acquisition unit 21 obtains the conflicting transfer requests from bus masters M.

In step d3, model generation unit 22 determines a transfer request to be granted the bus access right, among conflict transfer requests, based on action value function Q (st, at). Model generation unit 22 outputs the transfer request determined to be granted the bus access right to transfer request arbitration device 15. Transfer request arbitration device 15 transmits a signal for granting the bus access right to bus master M which is the source of the transfer request determined to be granted the bus access right. Data transfers are performed between bus master M and bus slaves S.

In step d4, reward computing unit 23 calculates a transaction time for the transfer request granted the bus access right. Based on one or more transaction times in the past and the calculated transaction time, reward computing unit 23 calculates an average transaction time MT.

In steps d5 and d7, if average transaction time MT decreases, the process proceeds to step d6, and if the average transaction time MT increases, the process proceeds to step d8.

In step d6, reward computing unit 23 increases the reward.

In step d8, reward computing unit 23 reduces the reward.

In step d9, function update unit 24 updates action value function Q (st, at) stored in a learned model storage unit, based on the reward.

Learning device 13 repeatedly performs these steps d1 to d9, and stores the generated action value function Q (st, at) into learned-model storage device 16, as a learned model.

### <Exploit Phase>

Transfer request arbitration device 15 obtains transfer requests from bus masters M. If the transfer requests from multiple bus masters M conflict, transfer request arbitration device 15 outputs the conflicting transfer requests to inference device 14.

Using action value function Q (st, at), which is the learned model, inference device 14 infers a transfer request to be granted the bus access right, among the conflicting transfer requests.

Data acquisition unit 31 obtains the conflicting transfer requests from bus masters M. The transfer request includes the address of a bus master M, the address of a bus slave S, the size of data to be transferred, and a time the transfer request is received.

Using the learned model for determining a transfer request to be granted the bus access right among conflicting transfer requests from multiple bus masters M, inference unit 32 determines a transfer request to be granted the bus access right among the conflicting transfer requests from the multiple bus masters M obtained by data acquisition unit 31.

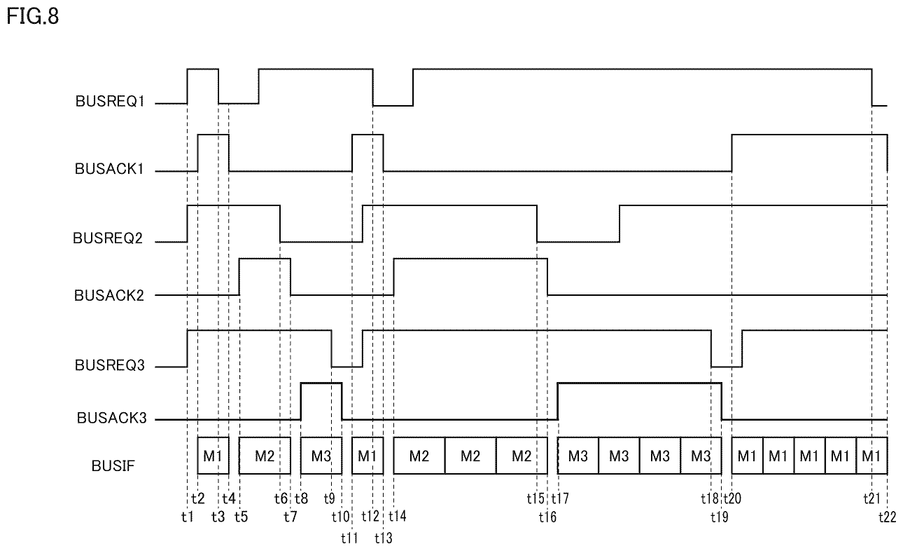

FIG. 8 is a diagram for illustrating an example of transitions of the state and the action during learning.

BUSREQ1, BUSREQ2, and BUSREQ3 represent transfer requests from bus masters M1, M2, and M3, respectively. BUSACK1, BUSACK2, and BUSACK3 represent granting of access rights to bus masters M1, M2, and M3, respectively. BUSIF represents data transmitted to bus 100. M1 represents a data transfer from a bus slave to bus master M1, M2 represents a data transfer from a bus slave to bus master M2, and M3 represents a data transfer from a bus slave to bus master M3.

At time t1, BUSREQ1, BUSREQ2, and BUSREQ3 conflict.

At time t2, based on action value function Q, access right BUSACK1 is granted to bus master M1 and a data transfer to bus master M1 starts.

At time t3, BUSREQ1 ends.

At time t4, access right BUSACK1 of bus master M1 ends and the data transfer to bus master M1 ends. Average transaction time MT is updated, and action value function Q is updated as a result.

Immediately after time t4, BUSREQ2 and BUSREQ3 conflict.

At time t5, based on action value function Q, access right BUSACK2 is granted to bus master M2 and a data transfer to bus master M2 starts.

At time t6, BUSREQ2 ends.

At time t7, access right BUSACK2 of bus master M2 ends and the data transfer to bus master M2 ends. Average transaction time MT is updated, and action value function Q is updated as a result.

Immediately after time t7, BUSREQ1 and BUSREQ3 conflict.

At time t8, based on action value function Q, access right BUSACK3 is granted to bus master M3 and a data transfer to bus master M3 starts.

At time t9, BUSREQ3 ends.

At time t10, access right BUSACK3 of bus master M3 ends and the data transfer to bus master M3 ends. Average transaction time MT is updated, and action value function Q is updated as a result.

Immediately after time t10, only BUSREQ1 is activated.

At time t11, access right BUSACK1 is granted to bus master M1 and the data transfer to bus master M1 starts.

At time t12, BUSREQ1 ends.

At time t13, access right BUSACK1 of bus master M1 ends and the data transfer to bus master M1 ends.

Immediately after time t13, BUSREQ2 and BUSREQ3 conflict.

At time t14, based on action value function Q, access right BUSACK2 is granted to bus master M2 and the data transfer to bus master M2 starts.

At time t15, BUSREQ2 ends.

At time t16, access right BUSACK2 of bus master M2 ends and the data transfer to bus master M2 ends. Average transaction time MT is updated, and action value function Q is updated as a result.

Immediately after time t16, BUSREQ1 and BUSREQ3 conflict.

At time t17, based on action value function Q, access right BUSACK3 is granted to bus master M3 and the data transfer to bus master M3 starts.

At time t18, BUSREQ3 ends.

At time t19, access right BUSACK3 of bus master M3 ends and the data transfer to bus master M3 ends. Average transaction time MT is updated, and action value function Q is updated as a result.

Immediately after time t19, BUSREQ1 and BUSREQ2 conflict.

At time t20, based on action value function Q, access right BUSACK1 is granted to bus master M1 and the data transfer to bus master M1 starts.

At time t21, BUSREQ1 ends.

At time t22, access right BUSACK1 of bus master M3 ends and the data transfer to bus master M1 ends. Average transaction time MT is updated, and action value function Q is updated as a result.

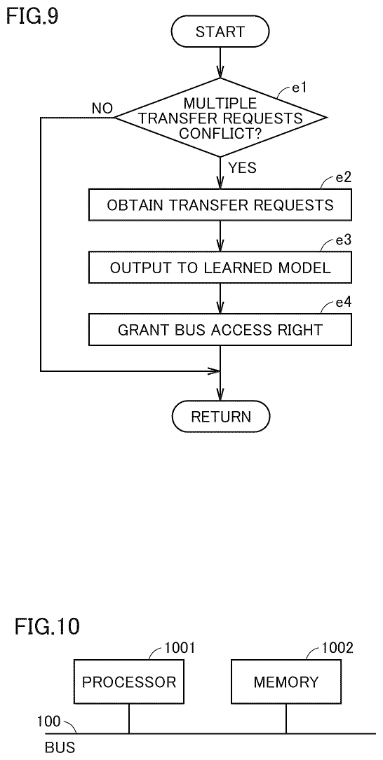

Next, referring to FIG. 9, a process by inference device 14 is described. FIG. 9 is a flowchart for an inference process by inference device 14 according to Embodiment 2.

In step e1, if transfer requests from multiple bus masters M conflict, data acquisition unit 31 obtains the conflicting transfer requests from transfer request arbitration device 15.

In step e2, inference unit 32 uses action value function Q (st, at), which is the learned model, to determine a transfer request to be granted a bus access right among the conflicting transfer requests. Inference unit 32 outputs the transfer request, determined to be granted the bus access right, to transfer request arbitration device 15.

In step e3, transfer request arbitration device 15 transmits a signal granting the bus access right to bus master M which is the source of the transfer request determined to be granted the bus access right. Data transfers are performed between bus master M and bus slaves S.

### Variation 1 of Embodiment 2

If the average bus latency decreases due to the bus access right being granted, model generation unit 22 may increase the reward, and if the average bus latency increases due to the bus access right being granted, model generation unit 22 may reduce the reward. The average bus latency is an average of latencies, during which no data is transmitted to the bus, in a predetermined time.

### Variation 2 of Embodiment 2

If the average wait time for bus masters M decreases due to the bus access right being granted, model generation unit 22 may increase the reward, and if the average wait time for bus masters M increases due to the bus access right being granted, model generation unit 22 may reduce the reward. The average wait time for bus masters M is an average time from a time the bus master M transmits a transfer request to a time the bus master M receives the bus access right.

A corresponding operation of bus control device 10 according to Embodiments 1 and 2 may be configured of hardware or software of a digital circuit.

FIG. 10 is a diagram showing a configuration of bus control device 10 whose functions are implemented using software. Bus control device 10 includes a processor 1001 and a memory 1002, which are connected to bus 100. Processor 1001 executes programs stored in memory 1002.

The presently disclosed embodiments should be considered in all aspects as illustrative and not restrictive. The scope of the present disclosure is defined by the appended claims, rather than by the above description. All changes which come within the meaning and range of equivalency of the appended claims are to be embraced within their scope.

### REFERENCE SIGNS LIST

1 semiconductor device; 10 bus control device; 11 transfer request storage device; 12 transfer time storage device; 13 learning device; 14 inference device; 15 transfer request arbitration device; 16 learned-model storage device; 21, 31 data acquisition unit (data obtainer); 22 model generation unit (model generator); 23 reward computing unit (reward computer); 24 function update unit (function updater); 32 inference unit (reasoner); 100 bus; 1001 processor; 1002 memory; M1 to MN bus master; and S1 to SN bus slave.

1. (canceled)

2. The learning device according to claim 4, wherein
when the bus occupancy time is shorter than a first occupancy time, the model generator increases a reward, and when the bus occupancy time is longer than a second occupancy time longer than the first occupancy time, the model generator reduces a reward.

3. (canceled)

4. A semiconductor device, comprising:
a plurality of bus masters;
a plurality of bus slaves;
a bus, interconnecting the plurality of bus masters and the plurality of bus slaves, for address transfers and data transfers between the plurality of bus masters and the plurality of bus slaves; and
a bus control device to control the address transfers and the data transfers via the bus, the bus control device including:
a memory device storing past transfer requests output from plurality of bus masters, priorities set to the transfer requests, and bus occupancy times by the data transfers based on the transfer requests; and
a learning device, including:
a data obtainer which obtains, as training data, an attribute of a transfer request whose bus occupancy time is shorter than a first occupancy time among the past transfer requests and a priority of the transfer request from the memory device; and
a model generator which generates, using the training data, a learned model for estimating, from the attribute of the transfer request, a priority allowing the bus occupancy time to be shorter than the first occupancy time.

5. The semiconductor device according to claim 4, wherein
the bus control device further includes an inference device including:
a data obtainer which obtains an attribute of a transfer request from a bus master; and
an reasoner which estimates, using a learned model for estimating a priority allowing a bus occupancy time to be shorter than a first occupancy time from an attribute of a transfer request, a priority allowing a bus occupancy time to be shorter than a first occupancy time, from the attribute of the transfer request obtained by the data acquisition obtainer.

6. The semiconductor device according to claim 5, wherein
the bus control device further includes a transfer request arbitration device which rearranges processing order of the transfer requests output from the plurality of bus masters, in response to the priority inferred by the reasoner.

7. The semiconductor device according to claim 4, wherein
the bus control device further includes a learned-model storage device holding a plurality of the learned models to enable selection of the learned model for use to a pattern of the transfer request to arbitrate the transfer requests.

8. A learning device, comprising:
a data obtainer to obtain training data including conflicting transfer requests from a plurality of bus masters and a transfer request to be granted a bus access right among the conflicting transfer requests from the plurality of bus masters; and
a model generator to generate, using the training data, a learned model for determining, from conflicting transfer requests from a plurality of bus masters, the transfer request to be granted the bus access right among the conflicting transfer requests from the plurality of bus masters wherein
when an average transaction time decreases due to the bus access right being granted, the model generator increases a reward, and when the average transaction time increases due to the bus access right being granted, the model generator reduces a reward.

9. (canceled)

10. The learning device according to claim 8, wherein
when an average bus latency decreases due to the bus access right being granted, the model generator increases a reward, and when the average bus latency increases due to the bus access right being granted, the model generation reduces a reward.

11. The learning device according to claim 8, wherein
when an average wait time for the bus master decreases due to the bus access right being granted, the model generator increases a reward, and when the average wait time of the bus master increases due to the bus access right being granted, the model generator reduces a reward.

12. (canceled)
